(19) United States
(12) Patent Application Publication
(10) Pub. No.: US 2026/0159446 A1
(43) Pub. Date: Jun. 11, 2026

(54) Gypsum Panel Containing Reclaimed Gypsum and a Water-Resistant Additive

(71) Applicant: Gold Bond Building Products, LLC, Charlotte, NC (US)

(72) Inventors: Christopher R. Fenoli, Charlotte, NC (US); Lucie Featherstone, Charlotte, NC (US); Ratnasabapathy Gurunathan Iyer, Fort Mill, SC (US)

(21) Appl. No.: 19/409,948

(22) Filed: Dec. 5, 2025

Related U.S. Application Data
(60) Provisional application No. 63/728,754, filed on Dec. 6, 2024.

(51) Int. Cl. C04B 18/04; C04B 16/04; C04B 18/167

(52) U.S. Cl. CPC C04B 18/0445; C04B 16/04; C04B 18/167

(57) ABSTRACT

The present disclosure is directed to a gypsum panel and a method of making such gypsum panel. Further, the present disclosure is directed to a method of processing a reclaimed gypsum panel. The method may include grinding a reclaimed gypsum panel and/or reclaimed gypsum panel pieces into a reclaim composition and separating at least a portion of the reclaimed facing material from the reclaimed gypsum of the reclaim composition. The reclaimed gypsum core of the reclaimed gypsum panel may include a reclaimed water-resistant additive present in a portion of the gypsum core adjacent at least one facing material of the reclaimed gypsum panel in a higher concentration than the center of the thickness of the gypsum core of the reclaimed gypsum panel.

### RELATED APPLICATIONS

The present application is based upon and claims priority to U.S. Provisional Patent Application Ser. No. 63/728,754, having a filing date of Dec. 6, 2024, which is incorporated herein by reference in its entirety.

### BACKGROUND OF THE INVENTION

In modern times, corporate sustainability initiatives and national environmental initiatives have become increasingly prominent and influential. Notably, the waste management of manufacturing processes has become a growing concern as manufacturers adjust their processes to better respond to environmental concerns of the manufacturer itself, the public, and administrative or governmental entities. As such, gypsum panel manufacturers have engaged in various corporate sustainability initiatives, including the incorporation of reclaimed gypsum panel components (i.e., waste gypsum panel components) in gypsum panels.

Generally, reclaimed gypsum panels are gypsum panels that possess one or more properties or characteristics that may be undesirable. In the past, gypsum panel manufacturers have had difficulty incorporating components of reclaimed gypsum panels in newly formed gypsum panels while also maintaining the desired characteristics and properties of the newly formed gypsum panels, particularly as the amount of reclaimed gypsum panel components increases in the newly formed gypsum panel, along with associated impurities. Notably, components of reclaimed gypsum panels containing water-resistant additives, such as siloxane, may be particularly difficult to incorporate into newly formed gypsum panels. Indeed, the water-resistant additives (e.g., siloxanes) originating from the reclaimed gypsum panels may negatively affect the densification of a gypsum panel and may result in foaming agent destabilization.

As a result, there is a need for an improved gypsum panel incorporating reclaimed water-resistant additives and a process of forming said gypsum panel.

### SUMMARY OF THE INVENTION

Aspects and advantages of the invention will be set forth in part in the following description, or may be obvious from the description, or may be learned through practice of the invention.

In accordance with one aspect of the present disclosure, a method of making a gypsum panel is disclosed. The method comprises: grinding a reclaimed gypsum panel and/or reclaimed gypsum panel pieces into a reclaim composition, the reclaim composition comprising reclaimed gypsum, reclaimed facing material, and a reclaimed water-resistant additive, the reclaimed gypsum panel comprising a reclaimed gypsum core and one or more facing materials, the reclaimed gypsum core comprising the reclaimed water-resistant additive, the reclaimed water-resistant additive being present in a portion of the reclaimed gypsum core adjacent at least one facing material in a higher concentration than the center of the thickness of the reclaimed gypsum core; separating at least a portion of the reclaimed facing material of the reclaim composition from the reclaimed gypsum to form a second reclaim composition, the second reclaim composition comprising the reclaimed gypsum in an amount of about 70 wt. % or more; providing a first facing material; depositing a gypsum slurry comprising water and the second reclaim composition, the second reclaim composition being optionally calcined; and providing a second facing material on the gypsum slurry.

In some implementations, the second reclaim composition is uncalcined. The reclaimed gypsum may be present in the gypsum slurry in an amount of 40 wt. % or less.

In some implementations, the second reclaim composition is calcined. The reclaimed gypsum of the second reclaim composition may be calcined into reclaimed stucco, the reclaimed stucco being present in the gypsum slurry in an amount of 0.001 wt. % or more.

In some implementations, the reclaimed facing material is present in the second reclaim composition in an amount of about 30 wt. % or less.

In some implementations, the reclaimed facing material is present in the gypsum slurry in an amount of about 5 wt. % or less.

In some implementations, the reclaimed water-resistant additive is a siloxane.

In some implementations, the concentration of the reclaimed water-resistant additive decreases across a portion of the thickness of the reclaimed gypsum core beginning at the portion of the reclaimed gypsum core adjacent the at least one facing material.

In some implementations, the reclaimed water-resistant additive is embedded in the reclaimed facing material.

In some implementations, the mass ratio of the concentration of the reclaimed water-resistant additive at an interface of the reclaimed gypsum core of the reclaimed gypsum panel and at least one facing material to the concentration of the reclaimed water-resistant additive at the center of the thickness of the reclaimed gypsum core is about 1.2:1 or more.

In some implementations, the reclaimed gypsum panel comprises an antimicrobial additive.

In some implementations, the reclaimed facing material is present in the gypsum slurry in an amount of about 5 wt. % or less; the reclaimed water-resistant additive is a siloxane; the concentration of the reclaimed water-resistant additive decreases across a portion of the thickness of the reclaimed gypsum core beginning at the portion of the reclaimed gypsum core adjacent the at least one facing material; the reclaimed water-resistant additive is embedded in the reclaimed facing material; and the mass ratio of the concentration of the reclaimed water-resistant additive at an interface of a reclaimed gypsum core of the reclaimed gypsum panel and the at least one facing material to the concentration of the reclaimed water-resistant additive at the center of the thickness of the reclaimed gypsum core is about 1.2:1 or more.

In accordance with another aspect of the present disclosure, a method of making a gypsum panel is disclosed. The method comprises: grinding a reclaimed gypsum panel and/or reclaimed gypsum panel pieces into a reclaim composition, the reclaimed gypsum panel comprising a reclaimed gypsum core and one or more facing materials, the reclaim composition comprising reclaimed gypsum, reclaimed facing material, and a reclaimed water-resistant additive, the reclaimed gypsum core comprising the reclaimed water-resistant additive, the reclaimed gypsum core having a concentration gradient of the reclaimed water-resistant additive over a portion of the thickness of the reclaimed gypsum core; separating at least a portion of the reclaimed facing material of the reclaim composition from the reclaimed gypsum to form a second reclaim composition, the second reclaim composition comprising the reclaimed gypsum in an amount of about 70 wt. % or more; providing a first facing material; depositing a gypsum slurry comprising water and the second reclaim composition, the second reclaim composition being optionally calcined; and providing a second facing material on the gypsum slurry.

In some implementations, the reclaimed facing material is present in the gypsum slurry in an amount of about 5 wt. % or less; the reclaimed water-resistant additive is a siloxane; the reclaimed water-resistant additive is embedded in the reclaimed facing material; and the mass ratio of the concentration of the reclaimed water-resistant additive at an interface of the reclaimed gypsum core of the reclaimed gypsum panel and the at least one facing material to the concentration of the reclaimed water-resistant additive at the center of the thickness of the reclaimed gypsum core is about 1.2:1 or more.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present disclosure is directed to a cementitious panel, particularly a gypsum panel, and a method of making such a cementitious panel. In particular, the gypsum panel can include a gypsum core including components of a reclaimed gypsum panel as defined herein. In this respect, the gypsum core may include gypsum (i.e., calcium sulfate dihydrate), one or more components of a reclaimed gypsum panel (e.g., reclaimed gypsum, one or more reclaimed water-resistant additives, and reclaimed facing material), and may include other optional additives. Notably, the present inventors have discovered that the process of forming the new gypsum panel disclosed herein may be particularly advantageous in limiting the negative effects resulting from the incorporation of one or more reclaimed water-resistant additives from a reclaimed gypsum panel and/or reclaimed gypsum panel pieces into the new gypsum panel. As used herein, “reclaimed gypsum panel pieces” refers to the reclaimed pieces of a gypsum panel. Notably, it should be understood that one or more pieces of a reclaimed gypsum panel may come from the production of a gypsum panel itself or from construction sites. In this respect, reclaimed gypsum panel pieces may include, for instance, gypsum panel pieces that result from a gypsum panel being cut or snapped at a construction site.

It should be understood that throughout the entirety of this specification, each numerical value (e.g., weight percentage) disclosed should be read as modified by the term “about” (unless already expressly so modified) and then read again as not to be so modified. For instance, a value of “100” is to be understood as disclosing “100” and “about 100”. Further, it should be understood that throughout the entirety of this specification, when a numerical range (e.g., weight percentage) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value. It should be understood that any concentration values disclosed herein may refer to mass or weight concentration, molar concentration, number concentration, or volume concentration.

It should be understood that, unless stated otherwise, any standard listed herein (e.g., ASTM) is the most recent version available as of the latest revision year. As used herein, the term “and/or” refers to one or all of the listed elements or a combination of any two or more of the listed elements. Notably, some aspects of the present disclosure may omit one or more of the features disclosed herein.

### Gypsum Panel and Reclaimed Gypsum Panel

In general, the gypsum core of a gypsum panel may comprise calcium sulfate dihydrate. The gypsum used to make the gypsum core may be from a natural source, a synthetic source, and/or from reclaim and is thus not necessarily limited by the present invention. In general, the gypsum, in particular the calcium sulfate dihydrate, may be present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum may be present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

In some aspects, the gypsum core may also comprise other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

The gypsum core of the present disclosure may be formed from a gypsum slurry. The gypsum slurry may comprise a reclaim composition (e.g., first reclaim composition, second reclaim composition). The reclaim composition may comprise any component of a reclaimed gypsum panel. For instance, the reclaim composition may comprise reclaimed gypsum, reclaimed facing material, one or more reclaimed water-resistant additives, or a combination thereof. In some aspects, the reclaim composition may comprise components of a reclaimed gypsum panel that are calcined or uncalcined. For instance, the reclaim composition may comprise reclaimed gypsum and/or reclaimed facing material that is calcined or uncalcined. It should be understood that reclaimed gypsum that is calcined may be referred to as reclaimed stucco. Notably, one or more components of a reclaimed gypsum panel present in the reclaim composition may be derived or originate from water-resistant gypsum panels.

In some aspects, the reclaimed facing material may include material from a paper facing material, a fibrous (e.g., glass fiber) mat facing material, a polymeric facing material, and/or a combination thereof.

A reclaim composition of the present disclosure may comprise water. For instance, water may be added to the reclaim composition. In this respect, the reclaim composition may be referred to as a reclaim slurry composition. The reclaim composition and/or any component thereof may comprise water in an amount of about 60 wt. % or less, such as about 50 wt. % or less, such as about 40 wt. % or less, such as about 30 wt. % or less, such as about 20 wt. % or less, such as about 15 wt. % or less, such as about 12 wt. % or less, such as about 10 wt. % or less, such as about 8 wt. % or less, such as about 5 wt. % or less, such as about 2 wt. % or less. The reclaim composition and/or any component thereof may comprise water in an amount of about 0.1 wt. % or more, such as about 0.5 wt. % or more, such as about 1 wt. % or more, such as about 2 wt. % or more, such as about 5 wt. % or more, such as about 8 wt. % or more, such as about 10 wt. % or more, such as about 15 wt. % or more, such as about 20 wt. % or more, such as about 30 wt. % or more, such as about 40 wt. % or more.

Alternatively, water may not be added to the reclaim composition. In this respect, the reclaim composition may be referred to as a dry reclaim composition. However, it should be understood that the dry reclaim composition may include one or more components of a reclaimed gypsum panel that comprise water, such as the chemically bound water of reclaimed gypsum.

Generally, water is combined with stucco to form a gypsum slurry. Notably, the inclusion of the reclaim composition may decrease the amount of water required to form a gypsum panel made in accordance with the present disclosure. For instance, the inclusion of the reclaim composition may decrease the amount of stucco required to form the gypsum panel, particularly the amount of stucco required to form the gypsum core. In this respect, less water may be utilized to react with the decreased amount of stucco.

Generally, the weight ratio of the water to the stucco in the gypsum slurry may be about 0.1 or more, such as about 0.2 or more, such as about 0.3 or more, such as about 0.4 or more, such as about 0.5 or more, such as about 0.6 or more, such as about 0.7 or more, such as about 0.8 or more, such as about 0.9 or more, such as about 1 or more. The weight ratio of the water to the stucco in the gypsum slurry may be about 4 or less, such as about 3.5 or less, such as about 3 or less, such as about 2.5 or less, such as about 2 or less, such as about 1.7 or less, such as about 1.5 or less, such as about 1.4 or less, such as about 1.3 or less, such as about 1.2 or less, such as about 1.1 or less, such as about 1 or less, such as about 0.9 or less, such as about 0.85 or less, such as about 0.8 or less, such as about 0.75 or less, such as about 0.7 or less, such as about 0.65 or less, such as about 0.6 or less, such as about 0.55 or less, such as about 0.5 or less, such as about 0.45 or less, such as about 0.4 or less, such as about 0.35 or less, such as about 0.3 or less, such as about 0.25 or less, such as about 0.2 or less.

A reclaim composition may decrease the energy utilized in forming a gypsum panel. For instance, as previously disclosed, a gypsum panel formed in accordance with the present disclosure may utilize less water than a traditional gypsum panel. In this respect, the energy utilized to heat or dry the gypsum panel in a heating or drying device may be decreased as a result of the gypsum slurry containing less water. Further, for instance, the energy utilized in calcining fresh rock to stucco may be decreased as less stucco may be utilized in the formation of the gypsum panel disclosed herein.

The inclusion of a reclaim composition and/or any component thereof in the gypsum slurry may be particularly advantageous in reducing the weight of a gypsum panel. For instance, the inclusion of the reclaimed gypsum and/or reclaimed facing material in the gypsum core and/or any component (e.g., a gypsum core layer) may result in a lightweight gypsum panel. Further, for instance, the reclaimed gypsum and/or reclaimed facing material may be included in a heavy gypsum panel to reduce the weight of the heavy gypsum panel while also allowing the heavy gypsum panel to maintain its advantageous properties.

In some aspects, the gypsum slurry may include one or more binders. The one or more binders may be included in the reclaim composition. The one or more binders may include a starch, a polymer, or a combination thereof. The one or more binders may enhance the strength and/or nail pull resistance of the gypsum panel. In one aspect, the one or more binders may form a secondary or tertiary binding matrix in the gypsum core, including any of the respective gypsum core layers. When two or more binders are utilized, the binders included in the binding matrix may be selectively chosen such that they have synergistic interactions with each other and/or with the other components of the gypsum panel. The one or more binders may be added at, before, and/or after any step in the process of forming the gypsum panel of the present disclosure.

Generally, the starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. Further, for instance, the starch may be a pregelatinized starch.

In general, the polymer may be a thermoplastic polymer. However, in one embodiment, the polymer may be a thermoset polymer. The polymer may also be one that expands, such as a foam, when exposed to heat and/or a flame. The polymer may include an acrylic polymer, a fluoropolymer, an epoxy, a urethane, a cyanurate, a rubber, an acetate polymer, or a mixture thereof. In one embodiment, the polymer may include an acrylic polymer (e.g., a vinyl toluene acrylic polymer, a styrene acrylic polymer, a silicone acrylic polymer, or a mixture thereof). In another embodiment, the polymer may include a fluoropolymer (e.g., polytetrafluoroethylene). In a further embodiment, the polymer may include an epoxy. In another further embodiment, the polymer may include a urethane polymer (e.g., polyurethane). In one embodiment, the polymer may include a cyanurate (e.g., polyisocyanurate). In a further embodiment, the polymer may include a rubber (e.g., chlorinated rubber). In another embodiment, the polymer may include an acetate polymer (e.g., polyvinyl acetate). In yet another embodiment, the polymer may include a styrene butadiene polymer.

In one embodiment, the polymer may be a viscoelastic polymer. For instance, the aforementioned acrylic polymer may be a viscoelastic polymer. In particular, the acrylic polymer may be an acrylic copolymer. In this regard, the polymer may be presented as a viscoelastic material having a broad glass transition temperature, in particular below room temperature. Such viscoelastic material may also include other additives as generally employed in the art and thus is not limited by the present disclosure. In general, such viscoelastic materials may allow for sound to be absorbed by the material thereby reducing the sound's amplitude and resulting energy of the sound.

In another embodiment, the one or more binders may include calcium sulfoaluminate (i.e., CSA Cement).

The one or more binders may be present in a gypsum panel and/or any component (e.g., gypsum core, gypsum slurry, reclaim composition) thereof, in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The one or more binders may be present in a gypsum panel and/or any component (e.g., gypsum core, gypsum slurry, reclaim composition) thereof, in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. Furthermore, the aforementioned weight percentages may be based on the weight of the gypsum slurry. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In yet another embodiment, the aforementioned weight percentages may be based on the weight of the gypsum in the respective gypsum core layer. In yet a further embodiment, the aforementioned weight percentages may be based on the weight of the reclaim composition. In yet another further embodiment, the aforementioned weight percentages may be based on the weight of the reclaimed gypsum in the reclaim composition.

One or more components of a reclaimed gypsum panel included in the reclaim composition may include one or more antimicrobial additives. In this respect, the reclaim composition may include one or more antimicrobial additives. The one or more antimicrobial additives may be added before, after, and/or during any step in the process of forming the gypsum panel of the present disclosure.

The one or more antimicrobial additives may be applied to and/or incorporated in reclaimed gypsum panels as a spray or more generally any method known in the art. In this respect, the one or more antimicrobial additives may be applied to a gypsum panel after the gypsum panel has been identified as a reclaimed gypsum panel (i.e., waste gypsum panel) and transferred into reclaimed gypsum panel storage. The reclaimed gypsum panel may be removed from reclaimed gypsum panel storage and one or more components of the reclaimed gypsum panel may be included in the reclaim composition of the present disclosure. In general, the application or inclusion of the one or more antimicrobial additives in a gypsum panel may increase the longevity of the gypsum panel.

The one or more antimicrobial additives may include a fungicide. For instance, the one or more antimicrobial additives may include more than one fungicide. In this respect, the one or more antimicrobial additives may include at least two fungicides, such as at least three fungicides.

The one or more antimicrobial additives may include various fungicides. For instance, the one or more antimicrobial additives may include an azole, a strobilurin, fludioxonil, an isothiazolinone, a pyrithione, or a combination thereof.

As indicated above, the one or more antimicrobial additives may include an azole. The azole may include any azole as generally known in the art. For instance, the azole may include thiabendazole, ketoconazole, fluconazole, itraconazole, voriconazole, posaconazole, ravuconazole, tebuconazole, fluconazole, bromuconazole, epoxiconazole, cyproconazole, flusilazole, metconazole, hexaconazole, difenoconazole, propiconazole, or a mixture thereof. In one embodiment, the fungicide may include thiabendazole, ketoconazole, fluconazole, metconazole, difenoconazole, propiconazole, or a mixture thereof. In one particular embodiment, the fungicide includes thiabendazole.

As indicated above, the one or more antimicrobial additives may include a strobilurin. The strobilurin may include any strobilurin as generally known in the art. For instance, the strobilurin may include azoxystrobin, kresoxim-methyl, picoxystrobin, fluoxastrobin, oryzastrobin, dimoxystrobin, pyraclostrobin, trifloxystrobin, or a mixture thereof. In one embodiment, the strobilurin includes azoxystrobin, azoxystrobin, trifloxystrobin, or a mixture thereof. In one particular embodiment, the strobilurin includes azoxystrobin.

As indicated above, the one or more antimicrobial additives may include fludioxonil.

As indicated above, the one or more antimicrobial additives may include an isothiazolinone. The isothiazolinone may include any isothiazolinone as generally known in the art. For instance, the isothiazolinone may include benzisothiazolinone, butylbenzisothiazolinone, octylisothiazolinone, dichlorooctylisothiazolinone, methylisothiazolinone, chloromethylisothiazolinone, or a mixture thereof. In one particular embodiment, the isothiazolinones may include a mixture of methylisothiazolinone and chloromethylisothiazolinone.

As indicated above, the one or more antimicrobial additives may include a pyrithione. The pyrithione may be any pyrithione as generally known in the art. For instance, the pyrithione may be a zinc pyrithione, a sodium pyrithione, a copper pyrithione, or a combination thereof. In one embodiment, the pyrithione may include at least a zinc pyrithione. In another embodiment, the pyrithione may include at least a sodium pyrithione. In a further embodiment, the pyrithione may include a zinc pyrithione and a sodium pyrithione.

In one aspect, the one or more antimicrobial additives may comprise an antimicrobial additive in the form of an aqueous dispersion. For instance, an aqueous dispersion of thiabendazole, azoxystrobin, and fludioxonil (e.g., SPORGARD® WB) may be included in the one or more antimicrobial additives incorporated into the gypsum panel disclosed herein.

In another aspect, the one or more antimicrobial additives may comprise diiodomethyl-p-tolyl sulfone (e.g., FUNGIBLOCK®).

In yet another aspect, the one or more antimicrobial additives may include boric acid, sodium omadine, smectite, pyrite, or a combination thereof.

The one or more antimicrobial additives may be present in a gypsum panel and/or any component (e.g., gypsum core, gypsum slurry, reclaim composition) thereof, in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The one or more antimicrobial additives may be present in a gypsum panel and/or any component (e.g., gypsum core, gypsum slurry, reclaim composition) thereof, in an amount of 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. Furthermore, the aforementioned weight percentages may be based on the weight of the gypsum slurry. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In yet another embodiment, the aforementioned weight percentages may be based on the weight of the gypsum in the respective gypsum core layer. In yet a further embodiment, the aforementioned weight percentages may be based on the weight of the reclaim composition. In yet another further embodiment, the aforementioned weight percentages may be based on the weight of the reclaimed gypsum in the reclaim composition.

Pre-formed gypsum crystals may reduce the setting time of the gypsum slurry. In this respect, the reclaim composition may include a set accelerant (e.g., reclaimed gypsum) comprising pre-formed gypsum crystals. As previously disclosed, the reclaim composition may comprise reclaimed gypsum. The reclaimed gypsum may comprise pre-formed gypsum crystals, which may be referred to as pre-formed calcium sulfate dihydrate crystals. The pre-formed gypsum crystals are pre-formed in the respect that the gypsum crystals are formed before being incorporated into the reclaim composition.

In some aspects, the gypsum core and/or a gypsum core layer (e.g., first gypsum core layer, second gypsum core layer, third gypsum core layer) formed in accordance with the present disclosure may have a heterogeneous density. In this respect, the varying sizes of the gypsum crystals may result in fluctuations or variations in the density of the gypsum core that may result in one or more respective gypsum core layers having a heterogeneous density.

In some aspects, the gypsum crystals formed from the reaction of stucco and water and the gypsum crystals formed by the templating or seeding action of pre-formed gypsum crystals (e.g., pre-formed gypsum crystals of the reclaim composition) in the presence of calcium ions and sulfate ions may form a gypsum crystalline matrix including crystals of various shapes. For instance, the gypsum crystals may be needle-shaped (e.g., acicular), tabular, bladed, or a combination thereof.

In some aspects, the inclusion of one or more components of a reclaimed gypsum panel (e.g., reclaimed gypsum and/or reclaimed facing material) as disclosed herein may be effective in improving the acoustical performance of a gypsum panel thereby minimizing the transmission of noise through a wall containing such gypsum panels. For instance, the sound transmission loss for a wall assembly including the gypsum panel as disclosed herein and as conducted in accordance with ASTM E90 may result in an STC rating of 20 or more, such as 25 or more, such as 30 or more, such as 35 or more, such as 40 or more, such as 45 or more, such as 50 or more, such as 55 or more, such as 60 or more. The STC rating may be less than 70, such as 65 or less, such as 60 or less, such as 55 or less, such as 50 or less, such as 45 or less, such as 40 or less. Such comparison may be determined based on a frequency curve as identified in ASTM E90.

In addition, at a frequency of 1000 Hz, the sound transmission loss of a gypsum panel formed in accordance with the present disclosure may be 55 dB or more, such as 56 dB or more, such as 57 dB or more, such as 58 dB or more, such as 60 dB or more. At a frequency of 2000 Hz, the sound transmission loss of a gypsum panel formed in accordance with the present disclosure may be more than 50 dB, such as 51 dB or more, such as 52 dB or more, such as 53 dB or more, such as 55 dB or more, such as 57 dB or more. At a frequency of 4000 Hz, the sound transmission loss of a gypsum panel formed in accordance with the present disclosure may be more than 52 dB, such as 53 dB or more, such as 55 dB or more, such as 57 dB or more, such as 59 dB or more, such as 60 dB or more.

Additionally, the noise reduction coefficient (“NRC”) of a gypsum panel incorporating one or more components of a reclaimed gypsum panel (e.g., reclaimed gypsum and/or reclaimed facing material) as disclosed herein may be enhanced. The noise reduction coefficient (“NRC”) is generally a measure of the sound absorption property of a gypsum panel. Generally, an NRC value may range from 0 to 1.00. As an example, an NRC value of 0.70 means that approximately 70% of the sound is absorbed by a panel, while approximately 30% is reflected back into the environment. In this regard, gypsum panels made according to the present disclosure may have higher NRC values than other types of gypsum panels and in certain instances even higher NRC values than certain mineral fiber panels, indicating improved sound absorbance and acoustical properties. For instance, the NRC value of the gypsum panel disclosed herein may be 0.10 or more, such as 0.15 or more, such as 0.21 or more, such as 0.23 or more, such as 0.25 or more, such as 0.27 or more, such as 0.29 or more, such as 0.30 or more, such as 0.31 or more, such as 0.32 or more, such as 0.33 or more, such as 0.34 or more, such as 0.35 or more, such as 0.36 or more, such as 0.37 or more, such as 0.38 or more, such as 0.39 or more, such as 0.40 or more, such as 0.41 or more, such as 0.42 or more, such as 0.43 or more, such as 0.44 or more, such as 0.45 or more, such as 0.46 or more, such as 0.47 or more, such as 0.48 or more, such as 0.49 or more, such as 0.50 or more. The NRC value of the gypsum panel may be 1.00 or less, such as 0.90 or less, such as 0.80 or less, such as 0.70 or less, such as 0.60 or less, such as 0.55 or less, such as 0.53 or less, such as 0.50 or less, such as 0.48 or less, such as 0.46 or less, such as 0.45 or less, such as 0.43 or less, 0.41 or less, such as 0.40 or less. In one embodiment, the aforementioned NRC values are based on ASTM C423, herein incorporated by reference in its entirety. In another embodiment, the aforementioned NRC values are based on ASTM E1050, herein incorporated by reference in its entirety. For example, such latter test may be employed for small-scale testing.

The reclaimed gypsum may be present in a gypsum panel and/or any component (e.g., gypsum core, gypsum slurry, reclaim composition) thereof, in an amount of about 99.9 wt. % or less, such as about 95 wt. % or less, such as about 90 wt. % or less, such as about 80 wt. % or less, such as about 70 wt. % or less, such as about 60 wt. % or less, such as about 50 wt. % or less, such as about 40 wt. % or less, such as about 30 wt. % or less, such as about 20 wt. % or less, such as about 10 wt. % or less. The reclaimed gypsum may be present in a gypsum panel and/or any component (e.g., gypsum core, gypsum slurry, reclaim composition) thereof, in an amount greater than about 0.001 wt. %, such as about 0.01 wt. % or more, such as about 0.1 wt. % or more, such as about 1 wt. % or more, such as about 5 wt. % or more, such as about 10 wt. % or more, such as about 20 wt. % or more, such as about 30 wt. % or more, such as about 40 wt. % or more, such as about 50 wt. % or more, such as about 60 wt. % or more, such as about 70 wt. % or more, such as about 80 wt. % or more, such as about 90 wt. % or more, such as about 95 wt. % or more, such as about 99 wt. % or more. The weight percentage may be based on the weight of the gypsum panel. Further, the weight percentage may be based on the weight of the gypsum core. In a further embodiment, such weight percentage may be based on the weight of a respective gypsum core layer. Furthermore, the aforementioned weight percentages may be based on the weight of the gypsum slurry. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In yet another embodiment, the aforementioned weight percentages may be based on the weight of the gypsum in the respective gypsum core layer. In yet a further embodiment, the aforementioned weight percentages may be based on the weight of the reclaim composition.

The reclaimed stucco may be present in the gypsum slurry and/or the reclaim composition in an amount of about 99.9 wt. % or less, such as about 95 wt. % or less, such as about 90 wt. % or less, such as about 80 wt. % or less, such as about 70 wt. % or less, such as about 60 wt. % or less, such as about 50 wt. % or less, such as about 40 wt. % or less, such as about 30 wt. % or less, such as about 20 wt. % or less, such as about 10 wt. % or less. The reclaimed stucco may be present in the gypsum slurry and/or the reclaim composition in an amount greater than about 0.001 wt. %, such as about 0.01 wt. % or more, such as about 0.1 wt. % or more, such as about 1 wt. % or more, such as about 5 wt. % or more, such as about 10 wt. % or more, such as about 20 wt. % or more, such as about 30 wt. % or more, such as about 40 wt. % or more, such as about 50 wt. % or more, such as about 60 wt. % or more, such as about 70 wt. % or more, such as about 80 wt. % or more, such as about 90 wt. % or more, such as about 95 wt. % or more, such as about 99 wt. % or more. The aforementioned weight percentages may be based on the weight of the gypsum slurry. In an even further embodiment, the aforementioned weight percentages may be based on the solids content of the gypsum slurry. Moreover, the aforementioned weight percentages may be based on the weight of the stucco, which may include virgin stucco and reclaimed stucco, in the gypsum slurry. Additionally, the aforementioned weight percentages may be based on the weight of a reclaim composition (e.g., first reclaim composition, second reclaim composition).

The reclaimed facing material may be present in a gypsum panel and/or any component (e.g., gypsum core, gypsum slurry, reclaim composition) thereof, in an amount less than about 40 wt. %, such as about 30 wt. % or less, such as about 20 wt. % or less, such as about 15 wt. % or less, such as about 12 wt. % or less, such as about 10 wt. % or less, such as about 8 wt. % or less, such as about 5 wt. % or less, such as about 2 wt. % or less. The reclaimed facing material may be present in a gypsum panel and/or any component (e.g., gypsum core, gypsum slurry, reclaim composition) thereof, in an amount greater than about 0.1 wt. %, such as about 0.5 wt. % or more, such as about 1 wt. % or more, such as about 2 wt. % or more, such as about 5 wt. % or more, such as about 8 wt. % or more, such as about 10 wt. % or more, such as about 15 wt. % or more, such as about 20 wt. % or more, such as about 30 wt. % or more. The weight percentage may be based on the weight of the gypsum panel. Further, the weight percentage may be based on the weight of the gypsum core. In a further embodiment, such weight percentage may be based on the weight of a respective gypsum core layer. Furthermore, the aforementioned weight percentages may be based on the weight of the gypsum slurry. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In yet another embodiment, the aforementioned weight percentages may be based on the weight of the gypsum in the respective gypsum core layer. In yet a further embodiment, the aforementioned weight percentages may be based on the weight of the reclaim composition. In yet another further embodiment, the aforementioned weight percentages may be based on the weight of the reclaimed gypsum in the reclaim composition.

The reclaim composition may be present in a gypsum panel and/or gypsum slurry in an amount less than about 95 wt. %, such as about 90 wt. % or less, such as about 80 wt. % or less, such as about 70 wt. % or less, such as about 60 wt. % or less, such as about 50 wt. % or less, such as about 45 wt. % or less, such as about 40 wt. % or less, such as about 35 wt, or less, such as about 30 wt. % or less, such as about 25 wt. % or less, such as about 20 wt. % or less, such as about 15 wt. % or less, such as about 10 wt. % or less, such as about 5 wt. % or less. The reclaim composition may be present in a gypsum panel and/or gypsum slurry in an amount greater than about 1 wt. %, such as about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 60 wt. % or more, such as about 70 wt. % or more, such as about 80 wt. % or more, such as about 90 wt. % or more. The weight percentage may be based on the weight of the gypsum panel. Further, the weight percentage may be based on the weight of the gypsum core. In a further embodiment, such weight percentage may be based on the weight of a respective gypsum core layer. Furthermore, the aforementioned weight percentages may be based on the weight of the gypsum slurry. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In yet another embodiment, the aforementioned weight percentages may be based on the weight of the gypsum in the respective gypsum core layer.

In one aspect, reclaimed gypsum panels and/or any component or pieces thereof may first be ground to a selectively chosen particle size and then included in the reclaim composition. The reclaimed gypsum panels and/or any component or pieces thereof may be milled or ground by dry grinding, which may be referred to as dry milling, or wet grinding, which may be referred to as wet milling.

In one aspect, the reclaimed gypsum and/or reclaimed facing material may be fine particles, coarse particles, or a combination thereof. For instance, the reclaimed gypsum and/or the reclaimed facing material may have an average particle size of 6000 microns or less, such as 5000 microns or less, such as 4500 microns or less, such as 4000 microns or less, such as 3500 microns or less, such as 3000 microns or less, such as 2500 microns or less, such as 2200 microns or less, such as 2000 microns or less, such as 1800 microns or less, such as 1500 microns or less, such as 1200 microns or less, such as 1000 microns or less, such as 800 microns or less, such as 500 microns or less, such as 400 microns or less, such as 300 microns or less, such as 200 microns or less, such as 150 microns or less, such as 100 microns or less, such as 75 microns or less, such as 50 microns or less, such as 40 microns or less, such as 25 microns or less, such as 15 microns or less, such as 10 microns or less, such as 5 microns or less, such as 1 micron or less, such as 900 nanometers or less, such as 800 nanometers or less, such as 600 nanometers or less, such as 500 nanometers or less, such as 300 nanometers or less, such as 200 nanometers or less, such as 100 nanometers or less. The reclaimed gypsum and/or reclaimed facing material may have an average particle size of 50 nanometers or more, such as 100 nanometers or more, such as 250 nanometers or more, such as 500 nanometers or more, such as 750 nanometers or more, such as 1 micron or more, such as 5 microns or more, such as 10 microns or more, such as 20 microns or more, such as 50 microns or more, such as 100 microns or more, such as 200 microns or more, such as 300 microns or more, such as 400 microns or more, such as 500 microns or more, such as 800 microns or more, such as 1000 microns or more, such as 1200 microns or more, such as 1500 microns or more, such as 1800 microns or more, such as 2000 microns or more, such as 2200 microns or more, such as 2500 microns or more, such as 3000 microns or more, such as 3500 microns or more, such as 4000 microns or more, such as 4500 microns or more, such as 5000 microns or more. Furthermore, in one aspect, the aforementioned values may refer to a median particle size of the reclaimed gypsum and/or reclaimed facing material. The average and/or median particle size may be determined by a laser diffractometer, such as a Microtrac S3500. The average and/or median particle size may be determined by dynamic image analysis, static image analysis, and/or dynamic light scattering. The average and/or median particle size may be determined via sieving. In some aspects, the aforementioned values may refer to the agglomerate size and the particle size of the reclaimed gypsum and/or reclaimed facing material. In this respect, the aforementioned values may refer to the combined average and/or combined median size of the agglomerates (i.e., particle agglomerates) and the individual particles of the reclaimed gypsum and/or reclaimed facing material.

The reclaimed gypsum and/or reclaimed facing material may have a selectively chosen particle size distribution. The particle size distribution of the reclaimed gypsum and/or reclaimed facing material may be monomodal, bi-modal, or multi-modal. The one or more modes may fall within any of the particle size values, including any ranges thereof, disclosed herein.

### Water-Resistant Additive

As previously disclosed herein, a gypsum panel formed in accordance with the present disclosure may include one or more reclaimed water-resistant additives from a reclaimed gypsum panel. In general, a reclaimed water-resistant additive may be a siloxane. For instance, the reclaimed water-resistant additive may be methyl hydrogen siloxane (i.e., polymethylhydrogensiloxane).

Generally, the siloxane may be a polyorganosiloxane. Notably, silicon-bonded organic groups of the siloxane may contain monovalent hydrocarbon and/or monovalent halogenated hydrocarbon groups. Such monovalent groups may have from 1 to about 20 carbon atoms, preferably from 1 to 10 carbon atoms, and are exemplified by, but not limited to, alkyl (e.g., methyl, ethyl, propyl, pentyl, octyl, undecyl, and octadecyl); cycloalkyl (e.g., cyclohexyl); alkenyl (e.g., vinyl, allyl, butenyl, and hexenyl); aryl (e.g., phenyl, tolyl, xylyl, benzyl, and 2-phenylethyl); and halogenated hydrocarbon groups (e.g., 3,3,3-trifluoropropyl, 3-chloropropyl, and dichlorophenyl). In general, at least 30%, such as at least 40%, such as about 50% of the organic groups are methyl.

In general, a siloxane may have the following general formula (II):

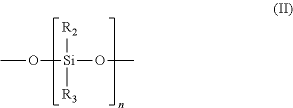

wherein,
n is an integer greater than 1; and
R₂ and R₃ are independently hydrogen, halogen, alkyl, cycloalkyl, aryl, heteroaryl, haloalkyl, haloaryl, alkoxy, carboxyalkyl, or alkenyl.

As indicated above, n is an integer greater than 1. In this regard, n may be 1 or more, such as 2 or more, such as 5 or more, such as 10 or more, such as 20 or more, such as 30 or more, such as 50 or more, such as 100 or more. In addition, n may be 500 or less, such as 400 or less, such as 300 or less, such as 200 or less, such as 150 or less, such as 125 or less, such as 100 or less, such as 80 or less, such as 60 or less, such as 50 or less, such as 40 or less, such as 30 or less.

As indicated above, R₂ and R₃ are independently hydrogen, halogen, alkyl, cycloalkyl, aryl, heteroaryl, haloalkyl, haloaryl, alkoxy, carboxyalkyl, or alkenyl. For instance, R₂ and R₃ may independently be a monovalent group typically containing from 1 to about 20 carbon atoms. The alkyl groups may be methyl, ethyl, propyl, pentyl, octyl, undecyl, octadecyl, etc. The alkoxy groups may be methoxy, ethoxy, propoxy, etc. The carboxyalkyl groups may be acetyl, etc. The cycloalkyl groups may be cyclohexyl, cyclooctyl, etc. The alkenyl groups may be vinyl, allyl, butenyl, hexenyl, etc. The aryl groups may be phenyl, tolyl, xylyl, benzyl, 2-phenylethyl, etc. The halogenated hydrocarbon groups may be 3,3,3-trifluoropropyl, 3-chloropropyl, dichlorophenyl, etc.

In one embodiment, at least one of R₂ and R₃ is hydrogen. In another embodiment, only one of R₂ and R₃ is hydrogen. In a further embodiment, at least one of R₂ and R₃ is alkyl. For instance, the alkyl may have 1 or more, such as 2 or more, such as 3 or more carbon atoms. The alkyl may have 20 or less, such as 16 or less, such as 12 or less, such as 10 or less, such as 8 or less, such as 6 or less, such as 4 or less, such as 2 or less carbon atoms. In one particular embodiment, only one of R₂ and R₃ is alkyl. In general, in one particular embodiment, the alkyl may be methyl.

Examples of one or more siloxanes (e.g., polyorganosiloxanes) that may be utilized as a reclaimed water-resistant additive include polydimethylsiloxane (“PDMS”), polymethylhydrogensiloxane, dimethyidiphenylpolysiloxane, dimethyl/methylphenylpolysiloxane, polymethylphenylsiloxane, methylphenyl/dimethylsiloxane, vinyldimethyl terminated polydimethylsiloxane, vinylmethyl/dimethylpolysiloxane, vinyldimethyl terminated vinylmethyl/dimethylpolysiloxane, divinylmethyl terminated polydimethylsiloxane, vinylphenylmethyl terminated polydimethylsiloxane, dimethylhydro terminated polydimethylsiloxane, methylhydro/dimethylpolysiloxane, methylhydro terminated methyloctylpolysiloxane, methylhydro/phenylmethyl polysiloxane, fluoro-modified polysiloxane, etc., or a mixture thereof. In one embodiment, a siloxane, such as the polyorganosiloxane, may be polydimethylsiloxane. In another embodiment, a siloxane, such as the polyorganosiloxane, may be polymethylhydrogensiloxane.

Notably, an organopolysiloxane may also contain one more pendant and/or terminal polar functional groups, such as hydroxyl, epoxy, carboxyl, amino, alkoxy, methacrylic, or mercapto groups, which impart some degree of hydrophilicity to the polymer. For example, an organopolysiloxane may contain at least one hydroxy group, and optionally an average of at least two silicon-bonded hydroxy groups (silanol groups) per molecule. Examples of such organopolysiloxanes may include, for instance, dihydroxypolydimethylsiloxane, hydroxy-trimethylsiloxypolydimethylsiloxane, etc. Alkoxy-modified organopolysiloxanes may also be employed, such as dimethoxypolydimethylsiloxane, methoxy-trimethylsiloxypolydimethylsiloxane, diethoxypolydimethylsiloxane, ethoxy-trimethylsiloxy-polydimethylsiloxane, etc. Notably, other suitable organopolysiloxanes are those modified with at least one amino functional group. Examples of such amino-functional polysiloxanes may include, for instance, diamino-functional polydimethylsiloxanes.

Generally, a siloxane may have a relatively high molecular weight. For example, a siloxane may have a molecular weight of about 500 g/mol or more, such as about 1,000 g/mol or more, such as about 1,500 g/mol or more, such as about 2,000 g/mol or more, such as about 3,000 g/mol or more, such as about 4,000 g/mol or more, such as about 5,000 g/mol or more, such as about 10,000 g/mol or more, such as about 25,000 g/mol or more. In general, a siloxane may have a molecular weight of about 500,000 g/mol or less, such as about 400,000 g/mol or less, such as about 300,000 g/mol or less, such as about 200,000 g/mol or less, such as about 150,000 g/mol or less, such as about 100,000 g/mol or less, such as about 50,000 g/mol or less, such as about 20,000 g/mol or less, such as about 10,000 g/mol or less, such as about 5,000 g/mol or less, such as about 4,000 g/mol or less, such as about 3,000 g/mol or less. Such molecular weight may be the molecular weight of the siloxane as provided to the gypsum slurry.

Notably, the reclaimed water-resistant additive may be heterogeneously or nonuniformly dispersed in a gypsum core of a reclaimed gypsum panel, which may be referred to as a reclaimed gypsum core. In one aspect, the concentration of the reclaimed water-resistant additive may be such that a concentration gradient of the reclaimed water-resistant additive is formed in a gypsum core of a reclaimed gypsum panel. It should be understood that the concentration may refer to mass or weight concentration, molar concentration, number concentration, or volume concentration.

Notably, methods to determine the concentration of a reclaimed water-resistant additive at various sections or portions of a reclaimed gypsum panel (e.g., center of the thickness of the gypsum core) are known to those skilled in the art. For instance, a sample from a section of portion of a board may be subjected to Nuclear Magnetic Resonance (NMR) Spectroscopy, X-Ray Diffraction (XRD), X-Ray Fluorescence (XRF) Spectroscopy, or Fourier Transform Infrared (FTIR) Spectroscopy. Notably, the concentration of a reclaimed water-resistant additive at the interface of a gypsum core and a facing material may be determined by separating the facing material from the gypsum core, scraping at least a portion of the residual gypsum from the facing material, and performing one of the aforementioned methods to determine the concentration of a reclaimed water-resistant additive at the interface of a gypsum core and a facing material.

In some aspects, the concentration gradient may be such that the concentration of the reclaimed water-resistant additive increases or decreases over a portion of the thickness, such as a thickness disclosed herein, of a gypsum core of a reclaimed gypsum panel. In one aspect, a gypsum core of a reclaimed gypsum panel may have a higher concentration of the reclaimed water-resistant additive in the portion of a gypsum core adjacent to the first facing material (e.g., the first gypsum core layer) with the concentration of the reclaimed water-resistant additive decreasing across a dimension (e.g., the thickness) of the gypsum core. In some aspects, the concentration of the reclaimed water-resistant additive in a gypsum core of a reclaimed gypsum panel may decrease across a thickness of a gypsum core beginning at the portion of a gypsum core adjacent the first facing material and ending at the portion of the gypsum core adjacent the second facing material or ending at the center of the thickness of the gypsum core. It should be understood that the center of the thickness of a gypsum core of a reclaimed gypsum panel is parallel to one or more respective facing materials and may be a plane that extends the length and width of the gypsum core.

In some aspects, a gypsum core of a reclaimed gypsum panel may have a higher concentration of the reclaimed water-resistant additive in the portion of the gypsum core adjacent to the second facing material (e.g., a third gypsum core layer or second gypsum core layer) with the concentration of the reclaimed water-resistant additive decreasing across a dimension (e.g., the thickness) of the gypsum core. In some aspects, the concentration of a reclaimed water-resistant additive in a gypsum core of a reclaimed gypsum panel may decrease across the thickness of the gypsum core beginning at the portion of the gypsum core adjacent the second facing material and ending at the portion of the gypsum core adjacent the first facing material or ending at the center of the thickness of the gypsum core.

In some aspects, a gypsum core (e.g., set gypsum core) of a reclaimed gypsum panel formed in accordance with the present disclosure may have a higher concentration of the reclaimed water-resistant additive in the portion of the gypsum core adjacent to the first facing material as compared to the concentration of the reclaimed water-resistant additive in the portion of the gypsum core adjacent to the second facing material. In this respect, the concentration of the reclaimed water-resistant additive in the portion of the gypsum core adjacent to the first facing material may be higher than the concentration of the reclaimed water-resistant additive in the portion of the gypsum core adjacent to the second facing material. As used herein, a “set gypsum core” refers to the gypsum core after the drying process of the gypsum panel, which may include drying the gypsum panel in a heating or drying device (e.g., kiln). In another aspect, a gypsum core (e.g., set gypsum core) of a reclaimed gypsum panel formed in accordance with the present disclosure may have a higher concentration of the reclaimed water-resistant additive in the portion of the gypsum core adjacent to the second facing material as compared to the concentration of the reclaimed water-resistant additive in the portion of the gypsum core adjacent to the first facing material. In this respect, the concentration of the reclaimed water-resistant additive in the portion of the gypsum core adjacent to the second facing material may be higher than the concentration of the reclaimed water-resistant additive in the portion of the gypsum core adjacent to the first facing material.

In some aspects, the concentration of the reclaimed water-resistant additive in the gypsum core (e.g., set gypsum core) of a reclaimed gypsum panel may be higher in the portions of the gypsum core adjacent to the respective facing materials. For instance, the concentration of the reclaimed water-resistant additive in the gypsum core may be higher in the portions of the gypsum core adjacent the first facing material and the second facing material, as compared to the center of the thickness of the gypsum core. In some aspects, a gypsum core formed in accordance with the present disclosure may have a higher concentration of the reclaimed water-resistant additive adjacent to the first facing material and the second facing material with the concentration of the reclaimed water-resistant additive decreasing toward the center of the thickness of the gypsum core beginning at the portions of the gypsum core adjacent the first facing material and second facing material respectively.

Notably, in some aspects, the three highest concentrations of the reclaimed water-resistant additive in a gypsum core (e.g., set gypsum core) of a reclaimed gypsum panel may be at the portion of the gypsum core adjacent the first facing material, at the center of the thickness of the gypsum core, and at the portion of the gypsum core adjacent the second facing material respectively. In this respect, the area of a gypsum core between the portion of the gypsum core adjacent the first facing material and the center of the thickness of the gypsum core may have a reduced concentration of the reclaimed water-resistant additive compared to the concentration of the reclaimed water-resistant additive in the portion of the gypsum core adjacent the first facing material and the center of the thickness of the gypsum core. Further, the area of a gypsum core between the portion of the gypsum core adjacent the second facing material and the center of the thickness of the gypsum core may have a reduced concentration of the reclaimed water-resistant additive compared to the concentration of the reclaimed water-resistant additive in the portion of the gypsum core adjacent the second facing material and the center of the thickness of the gypsum core.

Notably, it should be understood that a portion of a gypsum core may refer to a portion of a thickness of a gypsum core, such as 1/32 inches or more, such as 1/16 inches or more, such as 1/12 inches or more, such as ⅛ inches or more, such as ¼ inches or more. In this respect, in some aspects, a portion of a gypsum core adjacent to a facing material may be 1/12 inches or more. It should be understood that a portion of a gypsum core may refer to a portion of a thickness of a gypsum core, such as ½ inches or less, such as ¼ inches or less, such as ⅛ inches or less, such as 1/12 inches or less, such as 1/16 inches or less. In this respect, in some aspects, a portion of a gypsum core adjacent to a facing material may be ½ inches or less.

It should also be understood that a portion of a gypsum core of a reclaimed gypsum panel adjacent to a facing material may refer to the portion of a gypsum core at the interface of the gypsum core and a facing material.

Notably, the portion of a gypsum core of a reclaimed gypsum panel adjacent to a facing material may be parallel to one or more respective facing materials and may be a plane that extends the length and width of the gypsum core.

Further, it should be understood that the portion of a gypsum core of a reclaimed gypsum panel adjacent to the first facing material may be referred to as the first gypsum core layer. Additionally, when a gypsum core of a reclaimed gypsum panel includes two gypsum core layers, the portion of the gypsum core adjacent to the second facing material may be referred to as the second gypsum core layer. Further, when a gypsum core of a reclaimed gypsum panel includes three gypsum core layers, the portion of the gypsum core adjacent to the second facing material may be referred to as the third gypsum core layer.

In one aspect, the ratio (e.g., mass ratio) of the concentration of the reclaimed water-resistant additive at the interface of the gypsum core and a facing material (e.g., the first facing material, the second facing material) to the concentration of the reclaimed water-resistant additive at the center of the thickness of the gypsum core may be from about 20:1 to about 1:20, including all incremental ratios therebetween. The ratio of the concentration of the reclaimed water-resistant additive at the interface of the gypsum core and a facing material (e.g., the first facing material, the second facing material) to the concentration of the reclaimed water-resistant additive at the center of the thickness of the gypsum core may be about 20:1 or less, such as about 15:1 or less, such as about 10:1 or less, such as about 5:1 or less, such as about 1:1 or less, such as about 1:5 or less, such as about 1:10 or less, such as about 1:15 or less. The ratio of the concentration of the reclaimed water-resistant additive at the interface of the gypsum core and a facing material to the concentration of the reclaimed water-resistant additive at the center of the thickness of the gypsum core may be about 1:20 or more, such as about 1:15 or more, such as about 1:10 or more, such as about 1:5 or more, such as about 1:1 or more, such as about 1.2:1 or more, such as about 1.5:1 or more, such as about 1.8:1 or more, such as about 2:1 or more, such as about 5:1 or more, such as about 10:1 or more, such as about 15:1 or more. It should be understood that any concentration values disclosed herein may refer to mass concentration, molar concentration, number concentration, or volume concentration.

### ADDITIONAL DISCLOSURES

Notably, the processing of a reclaimed gypsum panel having a heterogeneous or non-uniform distribution of a reclaimed water-resistant additive (e.g., a siloxane) may include separating one or more facing materials from the gypsum core and/or one or more gypsum core layers of a reclaimed gypsum panel. In this respect, the processing of a reclaimed gypsum panel may include separating at least a portion of a reclaimed facing material from the reclaimed gypsum panel and/or the reclaimed gypsum. Notably, a reclaimed gypsum panel comprising a reclaimed water-resistant additive may have a higher weight percentage or concentration (e.g., mass concentration) of the reclaimed water-resistant additive adjacent to and/or embedded in the facing materials of a reclaimed gypsum panel as opposed to other portions of the reclaimed gypsum panel (e.g., center of the thickness of the reclaimed gypsum panel). In this respect, removing at least a portion of a facing material from the reclaimed gypsum panel and/or the reclaimed gypsum may be particularly advantageous or suitable for reclaimed gypsum panels containing water-resistant additives having a heterogeneous or non-uniform distribution in the reclaimed gypsum panel. In some aspects, both facing materials of a reclaimed gypsum panel may be removed.

In some aspects, after the grinding or milling of a reclaimed gypsum panel and/or pieces thereof, the ground reclaim material may be separated into one or more reclaim compositions. It should be understood that one or more reclaim compositions (e.g., first reclaim composition, second reclaim composition, third reclaim composition) may have any of the properties and/or components of a reclaim composition as disclosed herein.

The one or more reclaim compositions may include reclaimed gypsum and/or reclaimed facing material. Notably, the reclaimed gypsum and the reclaimed facing material may be separated via size separation. For instance, in one aspect, one or more trommel screens may be used to separate the reclaimed gypsum from the reclaimed facing material. Further, for instance, one or more vibrating screens may be used to separate the reclaimed gypsum from the reclaimed facing material.

Notably, the reclaimed gypsum and the reclaimed facing material may be separated via weight and/or density separation. For instance, in one aspect, one or more gravity tables may be used to separate the reclaimed gypsum from the reclaimed facing material. Additionally, drying may be used to facilitate the grinding, shredding, and/or separation of reclaimed gypsum panels, ground reclaim material, and/or one or more reclaim compositions.

In one aspect, the reclaimed gypsum and the reclaimed facing material may be separated by dissolving the reclaimed gypsum in a solution and retaining the reclaimed facing material (e.g., reclaimed paper). Notably, a solution containing dissolved gypsum (e.g., reclaimed gypsum) can be reused in the process as gauging water or for some other purpose. In this respect, a solution including dissolved gypsum may be incorporated and/or applied to a gypsum panel and/or any component thereof. It should be understood that a reclaim composition having at least a portion of the reclaimed facing material removed therefrom may be referred to as a second reclaim composition. In general, it should be understood that a reclaim composition may be referred to as a first reclaim composition, a second reclaim composition, a third reclaim composition, a fourth reclaim composition, etc. after a process step, such as any of the process steps disclosed herein. In this respect, a reclaim composition may be delineated based on its stage within the process disclosed herein. A first reclaim composition, a second reclaim composition, a third reclaim composition, a fourth reclaim composition, etc. may have any of the properties and/or components of a reclaim composition as disclosed herein. Notably, a first reclaim composition, a second reclaim composition, a third reclaim composition, a fourth reclaim composition, etc. may be calcined during, before, and/or after any of the process steps disclosed herein.

A reclaim composition (e.g., a first reclaim composition, a second reclaim composition) may include reclaimed gypsum in an amount of from about 50 wt. % to about 100 wt. %, including all increments of 0.1 wt. % therebetween, such as about 60 wt. % to about 100 wt. %, such as about 80 wt. % to about 100 wt. %.

In some aspects, a reclaim composition (e.g., a first reclaim composition, a second reclaim composition) may include reclaimed gypsum in an amount of about 50 wt. % or more, such as about 60 wt. % or more, such as about 70 wt. % or more, such as about 80 wt. % or more, such as about 90 wt. % or more. A reclaim composition (e.g., a first reclaim composition, a second reclaim composition) may include reclaimed gypsum in an amount of about 100 wt. % or less, such as about 90 wt. % or less, such as about 80 wt. % or less, such as about 70 wt. % or less, such as about 60 wt. % or less.

A reclaim composition (e.g., a first reclaim composition, a second reclaim composition) may include reclaimed facing material (e.g., reclaimed paper) in an amount of from about 0 wt. % to about 50 wt. %, including all increments of 0.1 wt. % therebetween, such as about 0 wt. % to about 25 wt. %, such as about 0 wt. % to about 15 wt. %, such as about 0 wt. % to about 10 wt. %, such as about 0 wt. % to about 5 wt. %, such as about 0 wt. % to about 2 wt. %.

In some aspects, a reclaim composition (e.g., a first reclaim composition, a second reclaim composition) may include reclaimed facing material in an amount of about 0 wt. % or more, such as about 10 wt. % or more, such as about 20 wt. % or more, such as about 30 wt. % or more, such as about 40 wt. % or more. A reclaim composition (e.g., a first reclaim composition, a second reclaim composition) may include reclaimed facing material in an amount of about 50 wt. % or less, such as about 40 wt. % or less, such as about 30 wt. % or less, such as about 20 wt. % or less, such as about 10 wt. % or less, such as about 5 wt. % or less, such as about 4 wt. % or less, such as about 3 wt. % or less, such as about 2 wt. % or less, such as about 1 wt. % or less. Generally, the reclaimed facing material may include paper, glass fiber, polymers, or a combination thereof.

In general, the composition of the gypsum core (e.g., new gypsum core, reclaimed gypsum core) is not necessarily limited and may include any additives as known in the art. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In yet another embodiment, the aforementioned weight percentages may be based on the weight of the gypsum in the respective gypsum core layer. In yet a further embodiment, the aforementioned weight percentages may be based on the weight of the reclaim composition. In yet another further embodiment, the aforementioned weight percentages may be based on the weight of the reclaimed gypsum in the reclaim composition.

In some aspects, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, a gypsum panel formed in accordance with the present disclosure may be formed from a method as disclosed herein. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

In general, the composition of the gypsum slurry and gypsum core is not necessarily limited and may be any generally known in the art. Generally, in one embodiment, the gypsum core is made from a gypsum slurry including at least stucco and water. However, as indicated herein, the gypsum slurry may include a reclaim composition. In this respect, the reclaim composition may be added to the gypsum slurry at any point in the process of forming the gypsum panel. Further, any optional additives as indicated herein may also be added to the gypsum slurry or the reclaim composition.

In general, stucco may be referred to as calcined gypsum or calcium sulfate hemihydrate. The calcined gypsum may be from a natural source, a synthetic source, or reclaim and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be anhydrite (e.g., AII, AIII), α-hemihydrate, β-hemihydrate, or a mixture thereof.

In addition to the stucco, the gypsum slurry may also contain other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

As indicated above, the gypsum slurry may include water. Water may be employed for fluidity and also for rehydration of the gypsum to allow for setting.

The weight ratio of the water to the stucco may be 0.1 or more, such as 0.2 or more, such as 0.2 or more, such as 0.3 or more, such as 0.4 or more, such as 0.5 or more, such as 0.6 or more, such as 0.7 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In yet another embodiment, the aforementioned weight percentages may be based on the weight of the gypsum in the respective gypsum core layer. In yet a further embodiment, the aforementioned weight percentages may be based on the weight of the reclaim composition. In yet another further embodiment, the aforementioned weight percentages may be based on the weight of the reclaimed gypsum in the reclaim composition.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

In one aspect, the foaming agent may include one or more foam stabilizers, such as ethoxylated glycerin. The one or more foam stabilizers may be present in the gypsum slurry and/or gypsum core in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less by weight of the foaming agent. The one or more foam stabilizers may be present in the gypsum slurry and/or gypsum core in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more by weight of the foaming agent.

By utilizing a soap, foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1,000 microns or more. The gypsum slurry may have bubbles or voids having a median size of 1,400 microns or less, such as 1,300 microns or less, such as 1,200 microns or less, such as 1,100 microns or less, such as 1,000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In one aspect, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less. Notably, the aforementioned values may be based on the gypsum core.

In some aspects, the gypsum slurry and/or gypsum core may include one or more dispersants. The dispersant is not necessarily limited and may include any that can be utilized within the gypsum slurry. The dispersant may include carboxylates, sulfates, sulfonates, phosphates, mixtures thereof, etc.

In one embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate. In one embodiment, the phosphate may be sodium monofluorophosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less. Notably, the aforementioned values may be based on the gypsum core.

In some aspects, the gypsum slurry and/or gypsum core may include one or more surfactants. In general, the surfactant may be an anionic surfactant, a cationic surfactant, a non-ionic surfactant, a fluorinated surfactant, a silicon surfactant, or a mixture thereof. Generally, a surfactant may be in the form of a solid, a liquid, or a combination thereof.

As indicated above, in one embodiment, the surfactant may include an anionic surfactant. In general, anionic surfactants include those having one or more negatively charged functional groups. For instance, the anionic surfactant may include an alkali metal or ammonium salts of alkyl, aryl or alkylaryl sulfonates, sulfates, or a mixture thereof. In some aspects, the anionic surfactant may include ammonium lauryl sulfate, sodium lauryl sulfate, sodium octylphenol glycolether sulfate, sodium laureth sulfate, sodium myreth sulfate, sodium dodecylbenzene sulfonate, perfluorobutane sulfonate, dodecyl benzene sulfonate, alpha-olefin sulfonate, sodium lauryldiglycol sulfate, ammonium tritertiarybutyl phenol and penta- and octa-glycol sulfonates, sulfosuccinate salts such as disodium ethoxylated nonylphenol half ester of sulfosuccinic acid, disodium n-octyldecyl sulfosuccinate, sodium dioctyl sulfosuccinate, alpha olefin sulfonate and/or olefin sulfonate (e.g., sodium olefin sulfonates, such as sodium C14-C16 olefin sulfonate, sodium C14-C18 olefin sulfonate, and sodium C16-C18 olefin sulfonate), and mixtures thereof. Other examples include a C8-C22 alkyl fatty acid salt of an alkali metal, alkaline earth metal, ammonium, alkyl substituted ammonium, for example, isopropylamine salt, or alkanolammonium salt, a C8-C22 alkyl fatty acid ester, a C8-C22 alkyl fatty acid ester salt, and alkyl ether carboxylates. Further, the anionic surfactant may include a phosphate (alkyl-aryl ether phosphates, alkyl ether phosphates, etc.), a phosphite, a phosphonate, a carboxylate (e.g., sodium stearate, etc.), or a mixture thereof.

In one particular embodiment, the anionic surfactant may include a water-soluble salt, particularly an alkali metal salt, of an organic sulfur reaction product having in their molecular structure an alkyl radical containing from about 8 to 22 carbon atoms and a radical selected from the group consisting of sulfonic and sulfuric acid ester radicals. Organic sulfur based anionic surfactants include the salts of C₁₀-C₁₆ alkylbenzene sulfonates, C₁₀-C₂₂ alkane sulfonates, C₁₀-C₂₂ alkyl ether sulfates, C₁₀-C₂₂ alkyl sulfates, C₄-C₁₀ dialkylsulfosuccinates, C₁₀-C₂₂ acyl isothionates, alkyl diphenyloxide sulfonates, alkyl naphthalene sulfonates, C₁₀-C₂₀ alpha olefin sulfonates, and 2-acetamido hexadecane sulfonates. In one aspect, the anionic surfactant may include C₆-C₁₂ linear and/or branched alkyl sulfates and/or C₆-C₁₂ linear and/or branched alkyl ether sulfates. Organic phosphate based anionic surfactants include organic phosphate esters such as complex mono- or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Particular examples of anionic surfactants include a polyoxyethylene alkyl ether sulfuric ester salt, a polyoxyethylene alkylphenyl ether sulfuric ester salt, polyoxyethylene styrenated alkylether ammonium sulfate, polyoxymethylene alkylphenyl ether ammonium sulfate, and the like, and mixtures thereof. For instance, the anionic surfactant may include a polyoxyethylene alkyl ether sulfuric ester salt, a polyoxyethylene alkylphenyl ether sulfuric ester salt, or a mixture thereof. In some aspects, the anionic surfactant may include sulfated alkanolamide, glyceride sulfate, or a mixture thereof.

As indicated above, in one embodiment, the surfactant may include a non-ionic surfactant. In one aspect, the nonionic surfactant may be an amine oxide. In one aspect, the nonionic surfactant may be an ethoxylate. For instance, the nonionic surfactant may be an ethoxylated fatty alcohol, a linear alcohol ethoxylate (e.g., narrow-range ethoxylate, octaethylene glycol monododecyl ether, pentaethylene glycol monododecyl ether, etc.), an alkylphenol ethoxylate (e.g., a nonoxynol, octylphenol ethoxylate, etc.), a fatty acid ethoxylate, an ethoxylated fatty ester, or an ethoxylated amine. In some aspects, the nonionic surfactant may be and/or include fatty acid amides (e.g., polyethoxylated tallow amine, cocamide monoethanolamine, cocamide diethanolamine, etc.), fatty acid esters of glycerol (e.g., glycerol monostearate, glycerol monolaurate, etc.), fatty acid esters of sorbitol (e.g., sorbitan monolaurate, sorbitan monostearate, sorbitan tristearate, etc.), alkyl polyglycosides (e.g., decyl glucoside, lauryl glucoside, octyl glucoside, etc.), block copolymers of polyethylene glycol and polypropylene glycol, glycerol alkyl esters, alkyl polyglucosides, polyoxyethylene glycol octylphenol ethers, sorbitan alkyl esters, polyoxyethylene glycol sorbitan alkyl esters, and mixtures thereof. For instance, the non-ionic surfactant may include a polyethylene oxide condensate of an alkyl phenol (e.g., the condensation product of an alkyl phenol having an alkyl group containing from 6 to 12 carbon atoms in either a straight chain or branched chain configuration, with ethylene oxide (e.g., present in amounts equal to 1 to 40 moles)). The alkyl substituent may be derived, for example, from polymerized propylene, di-isobutylene, octane or nonene. Other examples include dodecylphenol condensed with 12 moles of ethylene oxide per mole of phenol; dinonylphenol condensed with 5 moles of ethylene oxide per mole of phenol; nonylphenol condensed with 9 moles of ethylene oxide per mole of nonylphenol and di-iso-octylphenol condensed with 5 moles of ethylene oxide. The non-ionic surfactant may be a condensation product of a primary or secondary aliphatic alcohol having from 8 to 24 carbon atoms, in either straight chain or branched chain configuration, with from 1 to about 40 moles of alkylene oxide per mole of alcohol. The non-ionic surfactant may include a compound formed by condensing ethylene oxide with a hydrophobic base formed by the condensation of propylene oxide with propylene glycol (e.g., Pluronics). In one embodiment, the surfactant may be a silicon surfactant such as a polyether-modified siloxane.

In some aspects, a surfactant may include an ethoxylated alcohol that may include carbon chain lengths ranging from 12 to 20 carbon atoms. For instance, an ethoxylated alcohol may include carbon chain lengths ranging from 12 to 20 carbon atoms. A surfactant may include a blend of ethoxylated alcohols that have carbon chain lengths ranging from 12 to 20 carbon atoms. For instance, surfactant may include a blend of ethoxylated alcohols having carbon chain lengths ranging from 12 to 20 carbon atoms.

In one embodiment, the surfactant may include a cationic surfactant. For instance, the surfactant may include a cationic surfactant such as water-soluble quaternary ammonium compounds, polyammonium salts, a polyoxyethylene alkylamine and the like. In some aspects, the surfactant may include a cationic surfactant such as a quaternary ammonium salt (e.g., cetrimonium bromide, cetylpyridinium chloride, benzalkonium chloride, benzethonium chloride, dimethyldioctadecylammonium chloride, and dioctadecyldimethylammonium bromide, etc.).

In some aspects, the gypsum slurry and/or gypsum core may include one or more starches. The starch may be one generally utilized in the art. Such starch may be combined with the stucco and water. In this regard, such starch may be present in the gypsum slurry as well as the resulting gypsum core and gypsum panel. In one aspect, one or more components of a gypsum panel may be free of starch. For instance, the gypsum core and/or gypsum slurry may be free of starch. In one aspect, a gypsum panel formed in accordance with the present disclosure may be free of starch.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example, in one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum panel, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100° C. or more. The gelling temperature may be 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively lower gelling temperature. Meanwhile, without intending to be limited by theory, modifications of the hydroxyl group, such as by replacement via ethoxylation, ethylation, oxidation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present invention.

In one aspect, the starch may be present in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

The manner in which the components of the gypsum slurry are combined is not necessarily limited. For instance, the gypsum slurry can be made using any method or device generally known in the art. In particular, the components of the gypsum slurry can be mixed or combined using any method or device generally known in the art. The components of the gypsum slurry may include a reclaim composition and any optional additives as indicated herein. The components of the gypsum slurry may be combined in any type of device, such as a mixer and in particular a pin mixer or pinless mixer. In this regard, the manner in which the components are incorporated into the gypsum slurry is not necessarily limited by the present disclosure. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soaps may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, and as previously disclosed, the calcium sulfate hemihydrate of the stucco may react with the water to hydrate the calcium sulfate hemihydrate into calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for dewatering of the gypsum slurry, in particular dewatering any free water instead of combined water of the gypsum slurry. Thereafter, the method may also comprise a step of cutting a continuous gypsum sheet into a gypsum panel. Then, after the cutting step, the method may comprise a step of supplying the gypsum panel to a heating or drying device. For instance, such a heating or drying device may be a kiln and may allow for the removal (e.g., evaporation) of any free water. The temperature and time required for drying in such heating device are not necessarily limited by the present disclosure.

The reclaim composition may be introduced to the gypsum slurry by various methods. For instance, in one aspect, the reclaim composition may be combined with stucco (i.e., calcium sulfate hemihydrate) before the stucco is reacted with water. In this respect, the stucco and the reclaim composition may be mixed before the stucco and the reclaim composition are reacted with water. The stucco and reclaim composition may be combined by any method known in the art or disclosed herein. For instance, the stucco and the reclaim composition may be mixed or combined as is or may be ground or milled together, such as by dry milling or wet milling. In yet another aspect, the reclaim composition may be combined with the stucco after the stucco has been introduced to water. In this respect, the reclaim composition may be combined with the stucco and water after the stucco and water have partially reacted. In yet another further aspect, the stucco, water, and reclaim composition may all be combined simultaneously to form the gypsum slurry.

In one embodiment, the gypsum core may include a first gypsum core layer and a second gypsum core layer. The first gypsum core layer may be between the first facing material (e.g., front of the panel) and the second gypsum core layer. In addition, the first gypsum core layer may have a density greater than the second gypsum core layer. Accordingly, the first gypsum core layer may be formed using a gypsum slurry without the use of a foaming agent and/or foam or with a reduced amount of foaming agent and/or foam, which may be utilized in forming the second gypsum core layer. In this regard, in one embodiment, the first gypsum core layer may have the same composition as the second gypsum core layer except that the second gypsum core layer may be formed using a foaming agent and/or foam or a greater amount of foaming agent and/or foam.

In one embodiment, the gypsum core may also include a third gypsum core layer. The third gypsum core layer may be provided between the second gypsum core layer and a second facing material (e.g., back of the panel). In one aspect, the third gypsum core layer may be located adjacent to the second facing material. Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of a foaming agent and/or foam or with a reduced amount of foaming agent and/or foam, which may be utilized in forming the second gypsum core layer. In this regard, in one embodiment, the third gypsum core layer may have the same composition as the second gypsum core layer except that the second gypsum core layer may be formed using a foaming agent and/or foam or a greater amount of foaming agent and/or foam.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include a foaming agent and/or foam or more foaming agent and/or foam than the first gypsum slurry. In this regard, in one embodiment, the first gypsum slurry may not include a foaming agent and/or foam. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include a foaming agent and/or foam or more foaming agent and/or foam than the third gypsum slurry. In this regard, in one embodiment, the third gypsum slurry may not include a foaming agent and/or foam. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

Regardless of the above, any of the additives disclosed herein may be present in any combination of gypsum core layers. In one aspect, one or more gypsum core layers may comprise the same additive or additives. Further, in one aspect, the one or more gypsum core layers may comprise different additives. The different additives of the one or more gypsum core layers may be chosen such that it is advantageous to have a particular additive in one gypsum core layer and a different additive in another, different gypsum core layer.

The gypsum panel disclosed herein may have many applications. For instance, the gypsum panel may be used as a standalone panel in construction for the preparation of walls, ceilings, floors, roofs, etc. As used in the present disclosure, the term “gypsum panel” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

In one embodiment, the gypsum panel may be processed such that any respective gypsum core layer may have an average void size of about 90 microns to about 1500 microns, such as about 90 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more. Generally, the average void size may be about 1,500 microns or less, such as about 1,300 microns or less, such as about 1,100 microns or less, such as about 1,000 microns or less, such as about 900 microns or less, such as about 800 microns or less, such as about 700 microns or less, such as about 600 microns or less, such as about 500 microns or less, such as about 400 microns or less, such as about 300 microns or less. In one embodiment, such core voids may reference any air voids due to voids generated from the use of a soap/foam. Furthermore, while the aforementioned references an average void size, it should be understood that in another embodiment, such size may also refer to a median void size.

The specific surface area of the gypsum core is not necessarily limited and may be from about 0.25 m²/g to about 5 m²/g. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more. The specific surface area of the gypsum core may be 5 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, the thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present disclosure is not necessarily limited by the aforementioned thicknesses.

In addition, the panel weight of the gypsum panel is not necessarily limited. The gypsum panel may have a panel weight of about 500 lbs/MSF to about 7000 lbs/MSF including all increments of 1 lb/MSF therebetween. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2100 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C1396-17. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396-17. The gypsum panel may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C1396-17 and ASTM C473-19. The gypsum panel may have an edge hardness of about 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17 and ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, as previously disclosed, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%+3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A method of making a gypsum panel comprising:
grinding a reclaimed gypsum panel and/or reclaimed gypsum panel pieces into a reclaim composition, the reclaim composition comprising reclaimed gypsum, reclaimed facing material, and a reclaimed water-resistant additive, the reclaimed gypsum panel comprising a reclaimed gypsum core and one or more facing materials, the reclaimed gypsum core comprising the reclaimed water-resistant additive, the reclaimed water-resistant additive being present in a portion of the reclaimed gypsum core adjacent at least one facing material in a higher concentration than the center of the thickness of the reclaimed gypsum core;
separating at least a portion of the reclaimed facing material of the reclaim composition from the reclaimed gypsum to form a second reclaim composition, the second reclaim composition comprising the reclaimed gypsum in an amount of about 70 wt. % or more;
providing a first facing material;
depositing a gypsum slurry comprising water and the second reclaim composition, the second reclaim composition being optionally calcined; and
providing a second facing material on the gypsum slurry.

2. The method of claim 1, wherein the second reclaim composition is uncalcined, wherein the reclaimed gypsum is present in the gypsum slurry in an amount of 40 wt. % or less.

3. The method of claim 1, wherein the second reclaim composition is calcined, the reclaimed gypsum of the second reclaim composition being calcined into reclaimed stucco, the reclaimed stucco being present in the gypsum slurry in an amount of 0.001 wt. % or more.

4. The method of claim 1, wherein the reclaimed facing material is present in the second reclaim composition in an amount of about 30 wt. % or less.

5. The method of claim 1, wherein the reclaimed facing material is present in the gypsum slurry in an amount of about 5 wt. % or less.

6. The method of claim 1, wherein the reclaimed water-resistant additive is a siloxane.

7. The method of claim 1, wherein the concentration of the reclaimed water-resistant additive decreases across a portion of the thickness of the reclaimed gypsum core beginning at the portion of the reclaimed gypsum core adjacent the at least one facing material.

8. The method of claim 1, wherein the reclaimed water-resistant additive is embedded in the reclaimed facing material.

9. The method of claim 1, wherein the mass ratio of the concentration of the reclaimed water-resistant additive at an interface of the reclaimed gypsum core of the reclaimed gypsum panel and the at least one facing material to the concentration of the reclaimed water-resistant additive at the center of the thickness of the reclaimed gypsum core is about 1.2:1 or more.

10. The method of claim 1, wherein the reclaimed gypsum panel comprises an antimicrobial additive.

11. The method of claim 1, wherein:
the reclaimed facing material is present in the gypsum slurry in an amount of about 5 wt. % or less;
the reclaimed water-resistant additive is a siloxane;
the concentration of the reclaimed water-resistant additive decreases across a portion of the thickness of the reclaimed gypsum core beginning at the portion of the reclaimed gypsum core adjacent the at least one facing material;
the reclaimed water-resistant additive is embedded in the reclaimed facing material; and
the mass ratio of the concentration of the reclaimed water-resistant additive at an interface of a reclaimed gypsum core of the reclaimed gypsum panel and the at least one facing material to the concentration of the reclaimed water-resistant additive at the center of the thickness of the reclaimed gypsum core is about 1.2:1 or more.

12. A method of making a gypsum panel comprising:
grinding a reclaimed gypsum panel and/or reclaimed gypsum panel pieces into a reclaim composition, the reclaimed gypsum panel comprising a reclaimed gypsum core and one or more facing materials, the reclaim composition comprising reclaimed gypsum, reclaimed facing material, and a reclaimed water-resistant additive, the reclaimed gypsum core comprising the reclaimed water-resistant additive, the reclaimed gypsum core having a concentration gradient of the reclaimed water-resistant additive over a portion of the thickness of the reclaimed gypsum core;
separating at least a portion of the reclaimed facing material of the reclaim composition from the reclaimed gypsum to form a second reclaim composition, the second reclaim composition comprising the reclaimed gypsum in an amount of about 70 wt. % or more;
providing a first facing material;
depositing a gypsum slurry comprising water and the second reclaim composition, the second reclaim composition being optionally calcined; and
providing a second facing material on the gypsum slurry.

13. The method of claim 12, wherein the second reclaim composition is uncalcined, wherein the reclaimed gypsum is present in the gypsum slurry in an amount of 40 wt. % or less.

14. The method of claim 12, wherein the second reclaim composition is calcined, the reclaimed gypsum of the second reclaim composition being calcined into reclaimed stucco, the reclaimed stucco being present in the gypsum slurry in an amount of 0.001 wt. % or more.

15. The method of claim 12, wherein the reclaimed facing material is present in the gypsum slurry in an amount of about 5 wt. % or less.

16. The method of claim 12, wherein the reclaimed water-resistant additive is a siloxane.

17. The method of claim 12, wherein the reclaimed water-resistant additive is embedded in the reclaimed facing material.

18. The method of claim 12, wherein the concentration of the reclaimed water-resistant additive decreases across the portion of the thickness of the reclaimed gypsum core beginning at the portion of the reclaimed gypsum core adjacent the at least one facing material.

19. The method of claim 12, wherein the mass ratio of the concentration of the reclaimed water-resistant additive at an interface of the reclaimed gypsum core of the reclaimed gypsum panel and the at least one facing material to the concentration of the reclaimed water-resistant additive at the center of the thickness of the reclaimed gypsum core is about 1.2:1 or more.

20. The method of claim 12, wherein:
the reclaimed facing material is present in the gypsum slurry in an amount of about 5 wt. % or less;
the reclaimed water-resistant additive is a siloxane;
the reclaimed water-resistant additive is embedded in the reclaimed facing material; and
the mass ratio of the concentration of the reclaimed water-resistant additive at an interface of the reclaimed gypsum core of the reclaimed gypsum panel and the at least one facing material to the concentration of the reclaimed water-resistant additive at the center of the thickness of the reclaimed gypsum core is about 1.2:1 or more.
